(19) United States
(12) Patent Application Publication
(10) Pub. No.: US 2002/0179833 A1
(43) Pub. Date: Dec. 5, 2002

(54) SPM physical characteristic measuring method, measurement program, and SPM device

(76) Inventors: Yoshiharu Shirakawabe, Chiba-shi (JP); Hiroshi Takahashi, Chiba-shi (JP); Tadashi Arai, Chiba-shi (JP)

Correspondence Address: ADAMS & WILKS, 50 Broadway, 31st Floor, New York, NY, 10004, US

(21) Appl. No.: 10/096,385

(22) Filed: Mar. 12, 2002

(30) Foreign Application Priority Data
May 31, 2001 (JP) 2001-165308

(51) Int. Cl. G21K 7/00

(52) U.S. Cl. 250/306; 250/307

(57) ABSTRACT

In order to perform measurements while canceling out the action of force due to heating even when wiring of a sample remains in an excited state, physical properties are measured both during excitation and with no excitation present and compared, a range of physical properties larger than physical properties for when no excitation is present are specified for during excitation, coordinates for this range are stored, and cancellation of just the difference with physical properties when no excitation is present is carried out using the coordinates of the specified range of the physical characteristics while measuring physical characteristics by again moving the cantilever along the surface of the sample during excitation.

### BACKGROUND OF THE INVENTION

1. Field of the Invention

The present invention relates to an SPM physical characteristic measuring method, a scanning probe microscope device and an SPM physical characteristic measuring program, relates to technology for measuring the shape of a sample surface with no excitation between the sample and a cantilever and with no contact between the sample and the cantilever, and in particular, technology that is useful for observing samples having wiring, such as IC chips, etc.

2. Description of Related Art

Typically, Scanning Probe Microscopes (hereinafter referred to as “SPM's”) measure the shape of the surface of a sample by scanning in parallel along the surface of a sample with a cantilever provided with a point (tip) at a front end.

Depending on the basic concept and application, an SPM may be a Scanning Tunnelling Microscope (“STM”), an Atomic Force Microscope (“AFM”), a Magnetic Force Microscope, or a Scanning Near field Optical Atomic Force Microscope (“SNOAM”).

In recent years, with respect to SPMI's, particular attention has been paid to AFM's because theoretically shape measurements can be carried out even when there is no excitation between the tip and the sample, and because use as microscopes (measuring equipment) having other functions such as Magnetic Force Microscopes (MFM's) etc. is possible by changing cantilevers. AFM's measure the shape of sample surfaces by scanning along the surfaces of a sample to be observed at a fixed height with a cantilever tip and detecting inter-atomic force (force of attraction or force of repulsion) as an extent of bending of the cantilever based on van der Waals force generated between the sample surface and the tip.

As a result, because, theoretically, measurement of shapes can be carried out without there being excitation between the tip and the sample, AFM's are used to observe the surface of samples that are insulators and for measuring the shapes with wiring of IC chips in an excited state, as well as being used for other types of measurements.

Because, theoretically, AFMs and MFMs etc. can measure the shape of sample surfaces without there being excitation between the sample and the cantilever and without there being contact between the sample and the cantilever, AFMs and MFMs are marketed as measuring equipment having a number of applications for measuring shapes when wiring is in an excited state and carrying out various other measurements while monitoring samples having wiring such as IC chips, etc.

Typically, when an AFM measures a shape such as that of an IC chip when the wiring is in an excited state, the cantilever is bent back due to heat generated at wiring and defect portions in accompaniment with excitation so that shape measurement cannot be performed in a reliable manner. In the AFM of the related art, it is desirable to reduce the input voltage or input current that excites the wiring and to put distance between the sample and the cantilever in order to cancel out the phenomena of bending due to heat.

However, when the input voltage etc. is lowered with AFMs of the related art, the measuring conditions are limited and a problem arises where various measurements cannot be carried out. Further, when the sample and cantilever are distanced from each other, interatomic force is not generated in an appropriate manner and resolution is lowered. Typically, the same problems occur with an MFM as occur with an AFM.

In order to resolve the aforementioned problems it is therefore the object of the present invention to provide an SPM physical characteristic measuring method, a scanning probe microscope device and an SPM physical characteristic measuring program capable of performing measurements while canceling out the action of force due to heating while keeping sample wiring in an excited state and without lowering input voltage etc. or distancing the sample and cantilever from each other.

### SUMMARY OF THE INVENTION

In order to achieve the aforementioned object, with an SPM physical characteristic measuring method for measuring physical characteristics of a sample during excitation of wiring provided at the sample by moving a cantilever provided with a tip at a front end along the surface of the sample, physical properties are measured both during excitation and with no excitation present and compared, a range of physical properties larger than physical properties for when no excitation is present are specified for during excitation, coordinates for this range are stored, and cancellation of just the difference with physical properties when no excitation is present is carried out using the coordinates of the specified range of the physical characteristics while measuring physical characteristics by again moving the cantilever along the surface of the sample during excitation. This canceling may be calculated by taking values obtained by subtracting just this difference from values measured during excitation as normalized measurement values or may also be carried out by scanning while compensating the distance between the cantilever and the sample.

A scanning probe microscope device of the present invention for measuring physical characteristics of a sample during excitation of wiring provided at the sample by moving a cantilever provided with a tip at a front end along the surface of the sample, comprises means for measuring and comparing physical properties both during excitation and with no excitation present, means for specifying a range of physical properties larger than physical properties for when no excitation is present for during excitation, means for storing the specified range of coordinates, and means for canceling just the difference with physical properties when no excitation is present using the coordinates of the specified range of the physical characteristics while measuring physical characteristics by again moving the cantilever along the surface of the sample during excitation. This canceling means may be calculated by taking values obtained by subtracting just this difference from values measured during excitation as normalized measurement values or may also be carried out by scanning while compensating the distance between the cantilever and the sample.

TOPO signals expressing the shape of the surface of the sample, magnetic property signals, or potentials or currents may be taken as the physical characteristics.

An SPM physical characteristic measuring program of this invention may also be characterized by a program for executing the procedure of the SPM physical characteristic measuring methods on a computer.

According to this program, an SPM physical characteristic measuring method may be provided by utilizing a computer. Further, a microscope is provided where each of the means are implemented as a result of a CPU reading a program describing the procedures for the method recorded in ROM and RAM so that the aforementioned methods are implemented.

Here, “program” is a data processing method described in an arbitrary language or description method and may be in the format of source code or binary code, etc. Here, “program” is by no means limited to a unitary configuration, and may include a configuration dispersed between a plurality of modules or libraries, or where functioning is achieved by separate programs typified by an operating system (OS) operating in unison. Well known configurations and procedures may be used as specific configurations for reading recording media of each device demonstrating the embodiments and for reading procedures and installation procedures after reading.

### BRIEF DESCRIPTION OF THE DRAWINGS

FIG. 1 is a structural block view of a scanning probe microscope device used in the embodiments of this invention.

FIG. 2 is a flowchart of the cantilever scanning control process of a first embodiment of the invention.

FIG. 3A is a TOPO signal during excitation of wiring X1 of the sample X.

FIG. 3B is a TOPO signal without excitation of wiring X1 of the sample X.

FIG. 3C is a sectional view of wiring X1 of the sample X.

FIG. 4A is a TOPO signal during excitation of wiring X1 of the sample X.

FIG. 4B is a TOPO signal without excitation of wiring X1 of the sample X.

FIG. 4C is a sectional view of wiring X1 of the sample X.

FIG. 5A is a view illustrating the situation at the time of the cantilever scanning control process during excitation of wiring X1 of the sample X.

FIG. 5B is a view illustrating the situation at the time of the cantilever scanning control process without excitation of wiring X1 of the sample X.

FIG. 6 is a flowchart of the cantilever scanning control process of a second embodiment of the invention.

FIG. 7 is a flowchart of the cantilever scanning control process of a third embodiment of the invention.

### DETAILED DESCRIPTION OF THE PREFERRED EMBODIMENTS

The following is a detailed description of this invention with reference to the drawings. It should be understood that the present invention is not limited to this embodiment.

First Embodiment

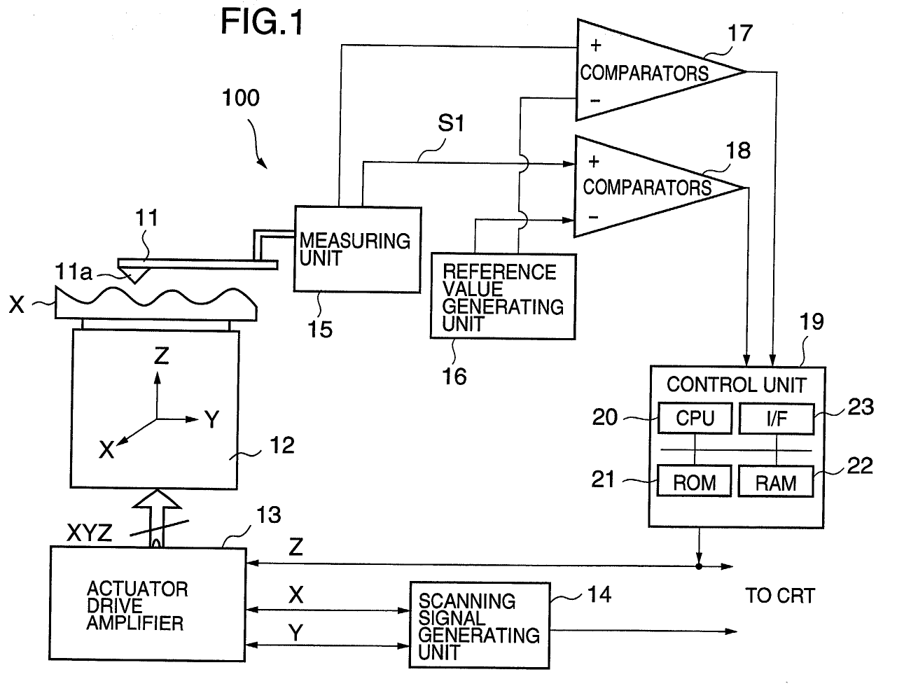

FIG. 1 is a structural block view of a scanning probe microscope device used in the embodiments of this invention. A scanning probe microscope device 100 is mainly comprised of a cantilever 11, a three-dimensional sample stage 12, an actuator drive amplifier 13, a scanning signal generating unit 14, a measuring unit 15, a reference value generating unit 16, comparators 17 and 18, and a control unit 19.

A front end of the cantilever 11 is sharpened so as to form a tip 11a. The tip 11a has a core portion composed of Si etc. which is coated with a conducting material or magnetic material. The cantilever 11 is arranged so that a sample X is facing the cantilever 11.

A cantilever 11 with conducting material coating the tip 11a is used when a voltage is applied across the surface of the sample X and the tip 1a or when a current flows. A cantilever 11 where the tip 11a is coated with a magnetic material is used when a magnetic force between the surface of the sample X and the tip 11a is measured (MFM). When just an AFM is used, a cantilever 11 where the tip 11a is not coated with various materials is used.

A piezoresistance (not shown) is provided at the surface of a free end of the cantilever 11. When the cantilever 11 then bends due to the action of the interatomic force between the surface of the sample X and the cantilever 11, the piezoresistance also becomes deformed at the same time due to this bending while measuring the shape of the surface of the sample X. The piezoresistance therefore generates a voltage in response to stress accompanying this deformation.

The sample X is put on and fixed to the three-dimensional sample stage 12

and the sample X can then be moved in three dimensions with respect to the cantilever 11 located above. Movement in the direction of the X-axis and the Y-axis then takes place when scanning the surface of the sample X with the cantilever 11. Movement in the Z direction takes place when adjusting the distance between the sample X and the cantilever 11.

The actuator drive amplifier 13 amplifies a control signal from the control unit 19 so as to move the three-dimensional sample stage 12.

The scanning signal generating unit 14 provides a fine adjustment signal for controlling fine adjustment within the XY plane of the sample X to the actuator drive amplifier 13 and supplies a raster scan signal to a CRT (not shown).

The measuring unit 15 applies a bias signal to the cantilever 11, amplifies an output signal according to displacement of the cantilever 11, and amplifies a TOPO signal (signal for unevenness of the sample X) and measurement signals for voltage, current and magnetic flux, etc. Each of the various amplified measurement signals etc. are then inputted to the non-inverting input terminals (+) of the comparators 17 and 18.

The reference value generating unit 16 generates reference values relating to each of the various measurement signals of the cantilever 11 for input to the inverting input terminals (−) of the comparators 17 and 18.

The comparators 17 and 18 compare the various measured values and the reference values and output the differences with the reference values to the control unit 19 as an error signal. The reference value is, for example, a value such that 0 is outputted when the amount of bending is 0.

The control unit 19 generates an image signal for displaying the state of the surface of the sample X and outputs this to a CRT (not shown), and controls the actuator drive amplifier 13 so that the error signal from the comparators 17 and 18 approaches 0 based on drive control of the three-dimensional sample stage 12, based on processing for deriving results of measurements of the surface of the sample X using measurement signals inputted from the measuring unit 15 and based on the results of the measurements.

In particular, when measuring the shape, the three-dimensional sample stage 12 is controlled in the Z direction is such a manner that the distance between the sample X and the cantilever 11 is fixed, i.e. so that the error signal approaches 0. The amount of displacement in the Z direction expresses unevenness of the sample X and is therefore displayed on the CRT (not shown) as a three-dimensional image perceived by the cantilever 11.

The control unit 19 carries out each of the various aforementioned processes as a result of a CPU 20 reading out and executing various programs and data from the ROM 21 and the RAM 22. The control unit 19 may also be realized using dedicated hardware.

An I/F (interface) 23 carries out exchange of data between the comparators 17 and 18, the actuator drive amplifier 13 and the CRT (not shown). The scanning probe microscope 100 also has terminals (not shown) for exciting wiring with respect to the sample X installed on the three-dimensional sample stage 12 and an excitation device (not shown) for providing excitation via these terminals.

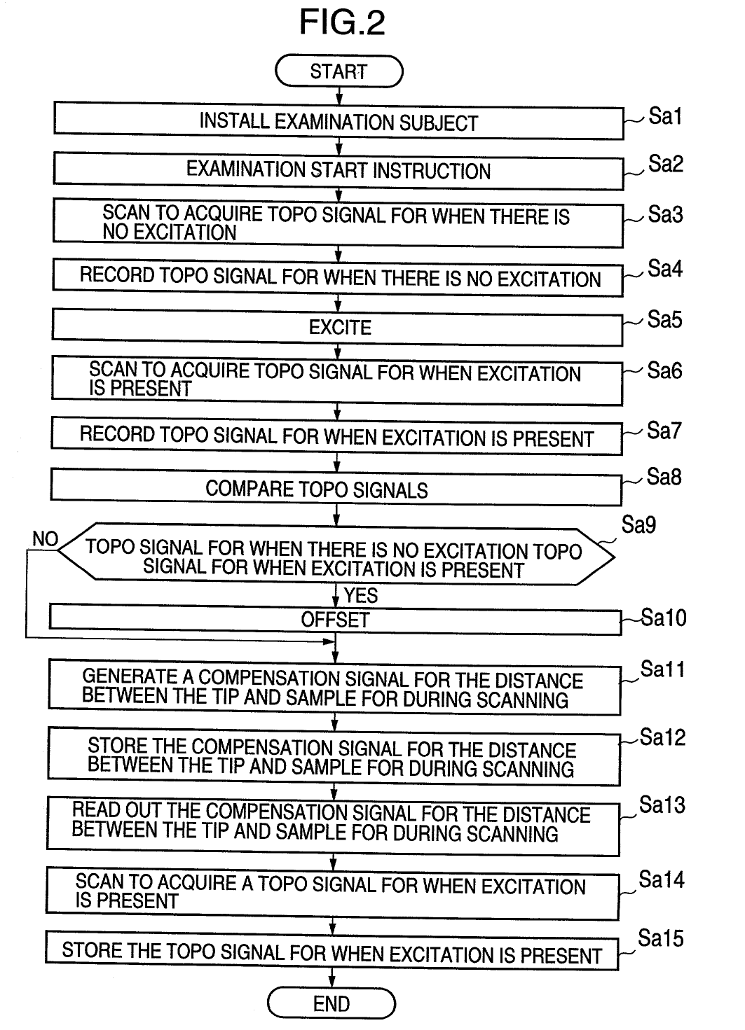

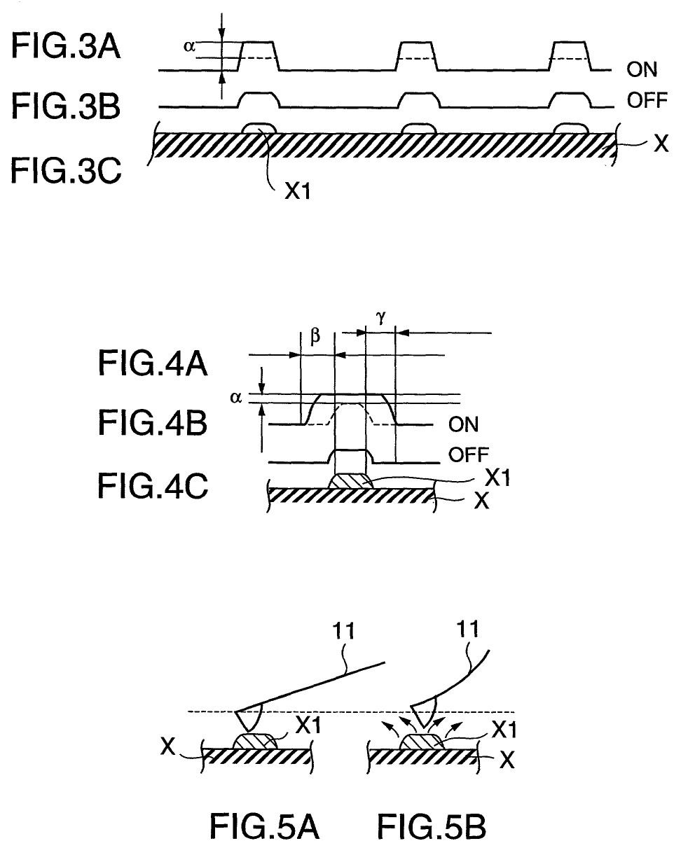

Next, a description is given of a cantilever scanning control process of the first embodiment of the invention. FIG. 2 is a flowchart of the cantilever scanning control process of the first embodiment of the invention. FIG. 3 is a view illustrating the concept of the cantilever scanning control process of the first embodiment of the invention.

First, the user installs a sample X such as an IC chip to be examined, etc. on the three-dimensional sample stage 12 (step Sa1). When a button (not shown) is then pressed down and an examination start instruction is inputted via a terminal (not shown), the examination start instruction is inputted to the control unit 19 (step Sa2). The sample X is installed on the three-dimensional sample stage 12 in such a manner that wiring is connected to the terminals (not shown).

In doing so, first, the control unit 19 causes the three-dimensional sample stage 12 to move with the wiring in a non-excited state, measurement of the shape of the surface of the sample X is carried out, and the measurement values are acquired as a TOPO signal for when there is no excitation and recorded (step Sa3, Sa4).

Next, the control unit 19 operates the excitation device (not shown) and excitation is started at the wiring of the sample X via terminals (not shown) (step Sa5). In this excited state, the three-dimensional sample stage 12 is caused to move, measurement of the shape of the surface of the sample X is carried out, and measurement values are acquired as a TOPO signal for the time of excitation and recorded (step Sa6, Sa7). The control unit 19 then compares the TOPO signal for when there is no excitation and the TOPO signal for when there is excitation, and establishes a distance (referred to as offset) between the sample X and the cantilever 11 in such a manner that canceling is performed just for a portion that is the surplus for the signal for this range when the TOPO signal for the time of excitation is a signal in a range greater than the TOPO signal for when there is no excitation(step Sa8, Sa9, Sa10). Signals outside the aforementioned range are taken to be normal signals.

For example, the TOPO signal shown in FIG. 3A during excitation of wiring X1 of the sample X shown in FIG. 3C is larger than the TOPO signal shown in FIG. 3B when there is no excitation by just a range α due to heating during excitation. In the above process, a distance is established between the sample X and the cantilever 11 of the portion of this range α in such a manner that just this range a is cancelled out.

The control unit 19 distances the sample X and the cantilever 11 in such a manner that just the surplus for when the TOPO signal during excitation is a signal of a range in excess of the TOPO signal when there is no excitation is cancelled. The amount of displacement in the direction of the Z-axis (described above as α) giving the extent to which the tip 11a and the sample X are distanced during scanning in an excited state and giving the distancing of the coordinates of this range are stored as a compensation signal (step Sa11, Sa12).

After this, the control unit 19 reads out the compensation signal (step Sa13), based on this compensation signal, the three-dimensional sample stage 12 is made to move in this excited state, the shape of the surface of the sample X is measured, and measurement values are acquired as a TOPO signal during excitation correctly expressing shape (step Sa14, Sa15).

Next, a description is given of a further example of a cantilever scanning control process of the first embodiment of the invention. FIG. 4 is a view illustrating the concept of the further example of a cantilever scanning control process of the first embodiment of the invention.

For example, the TOPO signal shown in FIG. 4A during excitation of wiring X1 of the sample X shown in FIG. 4C is larger than the TOPO signal shown in FIG. 4B when there is no excitation by just a range α due to heating during excitation, and becomes broader by ranges β and γ in a direction from left to right. In the case of this further example, canceling is carried out not only in the range α of the aforementioned process but also in the ranges β and γ. Compensation of the resolution accompanying heating can therefore be carried out as a result and measurement can be carried out at a high resolution.

A description is given of the situation during the cantilever scanning control process of the first embodiment of the invention. FIG. 5A and FIG. 5B are views illustrating the situation at the time of the cantilever scanning control process of the first embodiment of the invention.

When there is no excitation, as shown by FIG. 5A, the action of force due to heating from the wiring X1 of the sample X is weak, and during excitation, as shown by FIG. 5B, the action of force due to heating from the wiring X1 of the sample X is strong. The cantilever 11 therefore bends more during excitation than when there is no excitation. In the embodiments of this invention, processing is carried out so as to eliminate the influence of bending due to heating using a compensation signal when scanning a sample when excited.

According to the first embodiment, the action of the force due to heating is cancelled out and measurement can be performed even with the wiring of a sample remaining in an excited state and without having to lower the input voltage etc. or having to distance the sample and the cantilever from each other, other than for heated portions

Limits are therefore not placed on the measurement conditions, various measurements can be carried out, the benefits of acquiring a TOPO signal correctly during excitation can be obtained, and the benefits of high resolution can also be acquired.

Second Embodiment

The first embodiment gave a description for the case of a TOPO signal but a second embodiment deals with the case of a magnetic property signal. The block structure of the scanning probe microscope device 100 described for the first embodiment is the same and the following description therefore also refers to FIG. 1 as appropriate. However, the tip 11a of the cantilever 11 is taken to have a magnetic coat.

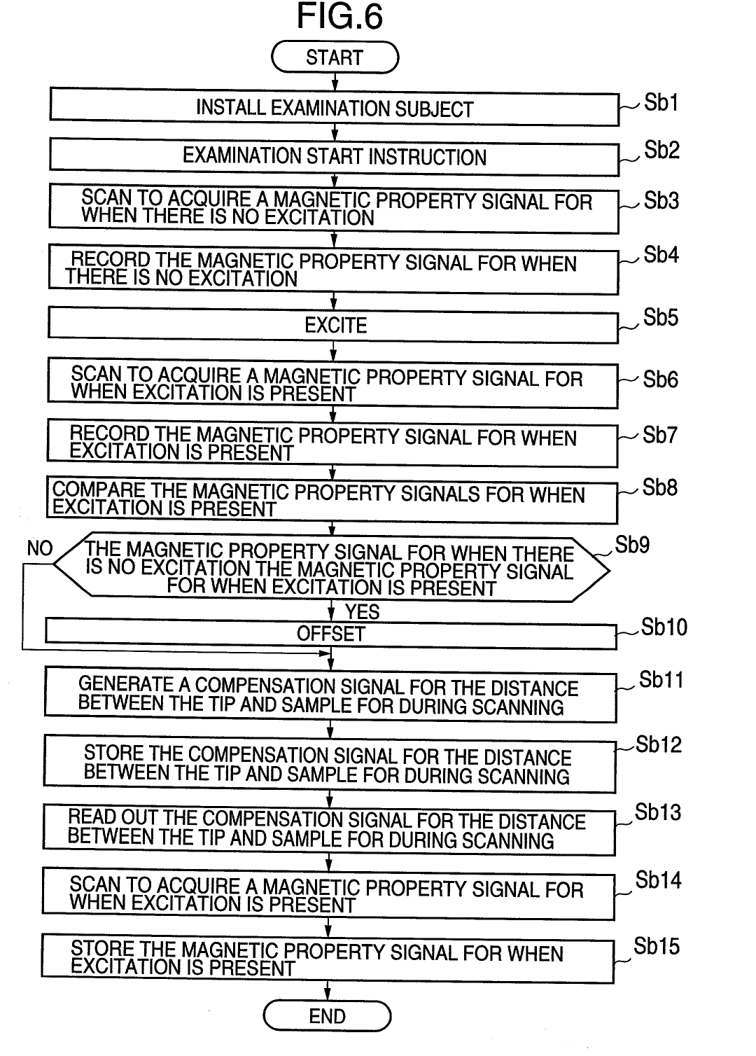

FIG. 6 is a flowchart of the cantilever scanning control process of a second embodiment of the invention. First, the user installs a sample X such as an IC chip to be examined, etc. on the three-dimensional sample stage 12 (step Sb1). When a button (not shown) is then pressed down and an examination start instruction is inputted via a terminal (not shown), the examination start instruction is inputted to the control unit 19 (step Sb2). The sample X is installed on the three-dimensional sample stage 12 in such a manner that wiring is connected to the terminals (not shown).

In doing so, first, the control unit 19 causes the three-dimensional sample stage 12 to move with the wiring in a non-excited state, measurement of the magnetic properties of the surface of the sample X is carried out, and measurement values (magnetic flux) are acquired as a magnetic property signal for when there is no excitation and recorded (step Sb3, Sb4).

Next, the control unit 19 operates the excitation device (not shown) and excitation is started at the wiring of the sample X via terminals (not shown) (step Sb5). In this excited state, the three-dimensional sample stage 12 is caused to move, measurement of the magnetic properties of the surface of the sample X is carried out, and measurement values are acquired as a magnetic property signal for the time of excitation and recorded (step Sb6, Sb7).

The control unit 19 then compares the magnetic property signal for when there is no excitation and the magnetic property signal for when there is excitation, and establishes a distance (referred to as offset) between the sample X and the cantilever 11 in such a manner that canceling is performed just for a portion that is the surplus for the signal for this range when the magnetic property signal for the time of excitation is a signal in a range greater than the magnetic property signal for when there is no excitation

(step Sb8, Sb9, Sb10). Signals outside the aforementioned range are taken to be normal signals.

The control unit 19 distances the sample X and the cantilever 11 in such a manner that just the surplus for when the magnetic property signal during excitation is a signal of a range in excess of the magnetic property signal when there is no excitation is cancelled. The amount of displacement in the direction of the Z-axis giving the extent to which the tip 11a and the sample X are distanced during scanning in an excited state and giving the distancing of the coordinates of this range are stored as a compensation signal (step Sb11, Sb12).

After this, the control unit 19 reads out the compensation signal (step Sb13), based on this compensation signal, the three-dimensional sample stage 12 is made to move in this excited state, the magnetic properties of the surface of the sample X are measured, and measurement values are acquired as a magnetic property signal during excitation correctly expressing magnetic properties (step Sb14, Sb15).

According to the second embodiment, the action of the force due to heating is cancelled out and measurement can be performed even with the wiring of a sample remaining in an excited state and without having to lower the input voltage etc. or having to distance the sample and the cantilever from each other, except for heated portions.

Limits are therefore not placed on the measurement conditions, various measurements can be carried out, the benefits of acquiring a magnet property signal correctly during excitation can be obtained, and the benefits of high resolution can also be acquired.

Third Embodiment

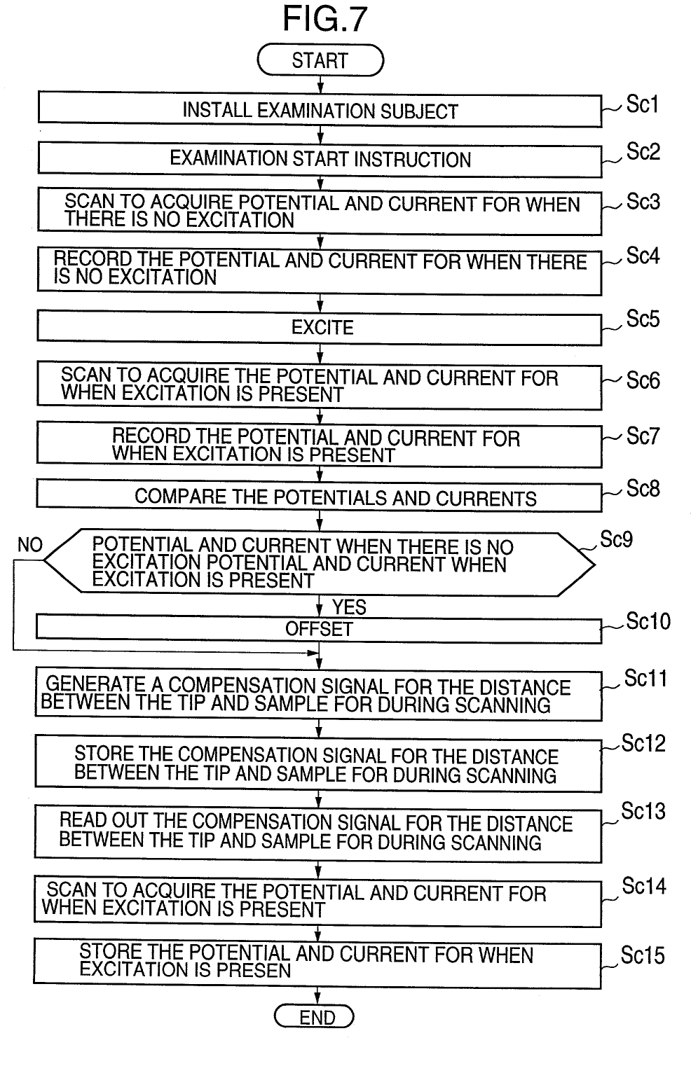

The first embodiment describes the case of a TOPO signal and the second embodiment describes a magnetic property signal, but the third embodiment deals with the case of potential and current. The block structure of the scanning probe microscope device 100 described for the first embodiment is the same and the following description therefore also refers to FIG. 1 as appropriate. However, the tip 1a of the cantilever 11 is taken to be coated with a conducting material. FIG. 7 is a flowchart of the cantilever scanning control process of a third embodiment of the invention.

First, the user installs a sample X such as an IC chip to be examined, etc. on the three-dimensional sample stage 12 (step Sc1). When a button (not shown) is then pressed down and an examination start instruction is inputted via a terminal (not shown), the examination start instruction is inputted to the control unit 19 (step Sc2). The sample X is installed on the three-dimensional sample stage 12 in such a manner that wiring is connected to the terminals (not shown).

In doing so, first, the control unit 19 causes the three-dimensional sample stage 12 to move with the wiring in a non-excited state, measurement of the potential and current at the surface of the sample X is carried out, and measurement values are acquired as the potential and current when there is no excitation and these values are recorded (step Sc3, Sc4).

Next, the control unit 19 operates the excitation device (not shown) and excitation is started at the wiring of the sample X via terminals (not shown) (step Sc5). In this excited state, the three-dimensional sample stage 12 is caused to move, measurement of the potential and current at the surface of the sample X is carried out, and measurement values are acquired as the potential and current at the time of excitation and recorded (step Sc6, Sc7).

The control unit 19 then compares the potential and current when there is no excitation and the potential and current when there is excitation, and establishes a distance (referred to as offset) between the sample X and the cantilever 11 in such a manner that canceling is performed just for a portion that is the surplus for the signal for this range when the potential and current at the time of excitation is a signal in a range greater than the potential and current when there is no excitation (step Sc8, Sc9, Sc10). Signals outside the aforementioned range are taken to be normal signals.

The control unit 19 distances the sample X and the cantilever 11 in such a manner that just the surplus for when the potential and current during excitation is in a range in excess of the potential and current when there is no excitation is cancelled. The amount of displacement in the direction of the Z-axis giving the extent to which the tip 11a and the sample X are distanced during scanning in an excited state and giving the distancing of the coordinates of this range are stored as a compensation signal (step Sc11, Sc12).

After this, the control unit 19 reads out the compensation signal (step Sc13), based on this compensation signal, the three-dimensional sample stage 12 is made to move in this excited state, the potential and current at the surface of the sample X is measured, and measurement values are acquired as the potential and current during excitation correctly expressing potential and current (step Sc14, Sc15). It is also possible to measure just one of either the potential or current.

According to the third embodiment, the action of the force due to heating is cancelled out and measurement can be performed even with the wiring of a sample remaining in an excited state and without having to lower the input voltage etc. or having to distance the sample and the cantilever from each other, except for heated portions.

Limits are therefore not placed on the measurement conditions, various measurements can be carried out, the benefits of acquiring the potential and the current correctly during excitation can be obtained, and the benefits of high resolution can also be acquired.

The scanning probe microscope device described in the above embodiments is by no means limited to the above configuration, providing that the configuration provides the same functions as described above. In the above embodiments, a description is given of the case of a self-detecting type where a piezoresistance is incorporated into the cantilever itself as a means of detecting bending of the cantilever. However, it is also possible to detect bending by illuminating the vicinity of the free end of the cantilever with laser light from a laser light source and detecting the reflected light using a detector.

Further, in the above embodiments a description is given of the case where just a difference with physical characteristics when there is no excitation is cancelled by carrying out scanning while compensating distancing between a cantilever and a sample at coordinates of a range for specified physical characteristics while moving a cantilever along the surface of a sample and measuring physical characteristics during excitation. The invention is, however, by no means limited in this respect, and this canceling may also be calculated by taking values obtained by subtracting just this difference from values measured during excitation as normalized measurement values.

As described above, according to this invention, the action of the force due to heating is cancelled out and measurement can be performed even with the wiring of a sample remaining in an excited state and without having to lower the input voltage etc. or having to distance the sample and the cantilever from each other, except for heated portions

Limits are therefore not placed on the measurement conditions, various measurements can be carried out, the benefits of acquiring physical characteristic signals such as TOPO signals accurately expressing the shape of the surface of a sample during excitation; magnetic property signals for during excitation, and potential and current during excitation can be obtained, and the benefits of high resolution can also be acquired.

What is claimed is:

1. An SPM physical characteristic measuring method for measuring physical characteristics of a sample during excitation of wiring provided at the sample by moving a cantilever provided with a tip at a front end along the surface of the sample, comprising the steps of:
measuring and comparing physical properties both during excitation and with no excitation present,
specifying a range of physical properties larger than physical properties for when no excitation is present for during excitation,
storing coordinates for this range, and
performing cancellation of just the difference with physical properties when no excitation is present using the coordinates of the specified range of the physical characteristics while measuring physical characteristics by again moving the cantilever along the surface of the sample during excitation.

2. The SPM physical characteristic measuring method of claim 1, wherein scanning is carried out while compensating the distance established between the cantilever and the sample, and canceling is performed for just the difference with the physical characteristics when there is no excitation at the coordinates of the specified range for the physical characteristics.

3. The SPM physical characteristic measuring method of claim 1, wherein TOPO signals representing the shape of the surface of the sample, magnetic property signals, or potentials or currents are taken as the physical characteristics.

4. The SPM physical characteristic measuring method of claim 1, wherein scanning is carried out while compensating the distance established between the cantilever and the sample, and canceling is performed for just the difference with the physical characteristics when there is no excitation at the coordinates of the specified range for the physical characteristics, and TOPO signals representing the shape of the surface of the sample, magnetic property signals, or potentials or currents are taken as the physical characteristics.

5. A scanning probe microscope device for measuring physical characteristics of a sample during excitation of wiring provided at the sample by moving a cantilever provided with a tip at a front end along the surface of the sample, comprising:
means for measuring and comparing physical properties both during excitation and with no excitation present;
means for specifying a range of physical properties larger than physical properties for when no excitation is present for during excitation, means for storing the specified range of coordinates; and
means for canceling just the difference with physical properties when no excitation is present using the coordinates of the specified range of the physical characteristics while measuring physical characteristics by again moving the cantilever along the surface of the sample during excitation.

6. The scanning probe microscope device of claim 5, wherein the canceling means is means for separating the distance between the cantilever and the sample, performing compensation, and performing scanning.

7. The scanning probe microscope device of claim 5, wherein TOPO signals representing the shape of the surface of the sample, magnetic property signals, or potentials or currents are taken as the physical characteristics.

8. The scanning probe microscope device of claim 5, wherein the canceling means is means for separating the distance between the cantilever and the sample, performing compensation, and performing scanning, and TOPO signals representing the shape of the surface of the sample, magnetic property signals, or potentials or currents are taken as the physical characteristics.

9. An SPM physical characteristic measuring program characterized by a program for executing the procedure of the SPM physical characteristic measuring method disclosed of claim 1 on a computer.

10. An SPM physical characteristic measuring program characterized by a program for executing the procedure of the SPM physical characteristic measuring method of claim 2 on a computer.

11. An SPM physical characteristic measuring program characterized by a program for executing the procedure of the SPM physical characteristic measuring of claim 3 on a computer.

12. An SPM physical characteristic measuring program characterized by a program for executing the procedure of the SPM physical characteristic measuring method of claim 4 on a computer.
